(19) United States
(12) Patent Application Publication
(10) Pub. No.: US 2025/0239636 A1
(43) Pub. Date: Jul. 24, 2025

(54) FUEL CELL SYSTEM AND METHOD FOR CHARGING AND DISCHARGING CONTROL OF ELECTRICAL POWER STORAGE DEVICE OF FUEL CELL SYSTEM

(71) Applicant: HONDA MOTOR CO., LTD., TOKYO (JP)

(72) Inventors: Ryoji SAKAI, WAKO-SHI (JP); Kazuhiro YAMAMOTO, WAKO-SHI (JP)

(21) Appl. No.: 19/019,730

(22) Filed: Jan. 14, 2025

(30) Foreign Application Priority Data
Jan. 23, 2024 (JP) 2024-007729

(51) Int. Cl. H01M 8/04746; H01M 8/04082; H01M 8/04111; H01M 8/0432; H01M 8/04537; H01M 8/04992; H01M 10/46; H01M 16/00; H02J 7/00

(52) U.S. Cl. CPC H01M 8/04776; H01M 8/04111; H01M 8/04201; H01M 8/04373; H01M 8/04626; H01M 8/04992; H01M 10/46; H01M 16/006; H01M 2250/402; H02J 7/0069

(57) ABSTRACT

A fuel cell system including a power storage device and an air pump sets a buffer that is allocated within a range of an amount of electrical power chargeable to and dischargeable from the power storage device, the buffer including, as an acceleration buffer, an amount of electrical power dischargeable from the power storage device to the air pump while a rotational speed of the air pump is accelerated, calculates steady AP power consumption of the air pump, and sets the acceleration buffer based on the calculated steady AP power consumption and rated electrical power of the air pump.

### CROSS-REFERENCE TO RELATED APPLICATIONS

This application is based upon and claims the benefit of priority from Japanese Patent Application No. 2024-007729 filed on Jan. 23, 2024, the contents of which are incorporated herein by reference.

### BACKGROUND OF THE INVENTION

### Field of the Invention

The present disclosure relates to a fuel cell system and a method for charging and discharging control of an electrical power storage device of the fuel cell system.

### Description of the Related Art

In recent years, research and development have been conducted on fuel cells that contribute to energy efficiency in order to ensure that more people have access to affordable, reliable, sustainable and modern energy.

A power generation system including a fuel cell stack is referred to as a fuel cell system. The fuel cell stack includes a plurality of power generation cells. The power generation cells generate electrical power by electrochemical reactions between a fuel gas (hydrogen-containing gas) and an oxygen-containing gas supplied from an air pump. The electrical power generated by the power generation cells is supplied to a load and charged in a power storage device.

For example, JP 2017-152280 A discloses a fuel cell system in which the range of the amount of electrical power charged to and discharged from a power storage device is limited.

In this fuel cell system, the limited range of the amount of electrical power to be charge or discharged is provided with a buffer, and the amount of electrical power corresponding to the buffer is allocated to drive an air pump. In the case that the temperature of the power storage device becomes low, the amount of electrical power corresponding to the buffer is set to be small. Thus, the amount of electrical power dischargeable from the power storage device to devices other than the air pump is increased.

### SUMMARY OF THE INVENTION

In a fuel cell system, it is desired to optimize the range of the amount of electrical power that can be charged to and discharged from a power storage device.

The present disclosure has the object of solving the aforementioned problem.

A first aspect of the present disclosure is to provide a fuel cell system including: a fuel cell configured to generate electrical power using a fuel gas and an oxygen-containing gas; a pump configured to feed the oxygen-containing gas to the fuel cell; a power storage device configured to be able to supply electrical power to the pump; and a control device configured to control power generation of the fuel cell and charging and discharging of the power storage device, wherein the control device sets a range of an amount of electrical power chargeable to and dischargeable from the power storage device, the range of the amount of electrical power chargeable to and dischargeable from the power storage device including a buffer including an acceleration buffer as an amount of electrical power dischargeable from the power storage device to the pump at a time of accelerating a rotational speed of the pump, and wherein the control device calculates steady power consumption of the pump and sets the acceleration buffer based on the steady power consumption and rated electrical power of the pump.

A second aspect of the present disclosure is to provide a method for controlling charge and discharge of a power storage device of a fuel cell system, the fuel cell system including: a fuel cell configured to generate electrical power using a fuel gas and an oxygen-containing gas; a pump configured to feed the oxygen-containing gas to the fuel cell; a power storage device configured to be able to supply electrical power to the pump; and a control device configured to control power generation of the fuel cell and charging and discharging of the power storage device, wherein the control device sets a range of an amount of electrical power chargeable to and dischargeable from the power storage device, the range of the amount of electrical power chargeable to and dischargeable from the power storage device including a buffer including an acceleration buffer as an amount of electrical power dischargeable from the power storage device to the pump at a time of accelerating a rotational speed of the pump, and wherein the control device calculates steady power consumption of the pump and sets the acceleration buffer based on the steady power consumption and rated electrical power of the pump.

A third aspect of the present disclosure is to provide a fuel cell system including: a fuel cell configured to generate electrical power using a fuel gas and an oxygen-containing gas; a pump configured to feed the oxygen-containing gas to the fuel cell; a power storage device configured to be able to supply electrical power to the pump; a control device configured to control power generation of the fuel cell and charging and discharging of the power storage device; and a temperature measurement device configured to measure a temperature of the power storage device, wherein the control device sets a range of an amount of electrical power chargeable to and dischargeable from the power storage device, the range of the amount of electrical power chargeable to and dischargeable from the power storage device including the buffer including the deceleration buffer as an amount of electrical power chargeable to the power storage device in a case where a surplus of electrical power generated due to deceleration of a rotational speed of the pump, and wherein the control device changes a buffer width of the deceleration buffer in accordance with the temperature of the power storage device, switches a current limit of the fuel cell based on the buffer width of the deceleration buffer, and causes the fuel cell to generate electrical power with the current limit as switched.

According to the present disclosure, in the fuel cell system, the range of the amount of electrical power that can be charged to and discharged from the power storage device can be optimized.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic configuration diagram of a fuel cell system according to the first embodiment;

FIG. 2 is a schematic view of a turbo air pump including an air bearing mechanism;

FIG. 3 is an explanatory diagram for explaining a limited range of charging and discharging of the power storage device;

FIG. 4 is a timing chart showing an example of a relationship between actual AP power consumption and steady AP power consumption of an air pump;

FIG. 5 is a flowchart for describing a flow of setting an acceleration buffer;

FIG. 6 is a timing chart showing an example of changes in the actual AP power consumption and the steady AP power consumption while accelerating a rotational speed of the air pump;

FIG. 7A is an explanatory diagram showing a change over time in rotational speed of the air pump in the second embodiment;

FIG. 7B is an explanatory diagram showing a change over time in an opening degree of a bypass valve;

FIG. 7C is an explanatory diagram showing a change over time in a flow rate of an oxygen-containing gas;

FIG. 7D is an explanatory diagram showing a change over time in dryness inside a fuel cell stack;

FIG. 8 is a flowchart showing a flow of setting a current limit of the fuel cell stack;

FIG. 9 is a timing chart showing an example of changes in the actual AP power consumption and the steady AP power consumption of the air pump under low temperature and under normal temperature; and

FIG. 10 is an explanatory diagram showing an example of the FC current limit in accordance with a temperature of the power storage device.

### DETAILED DESCRIPTION OF THE INVENTION

### First Embodiment

### Configuration of Fuel Cell System 10

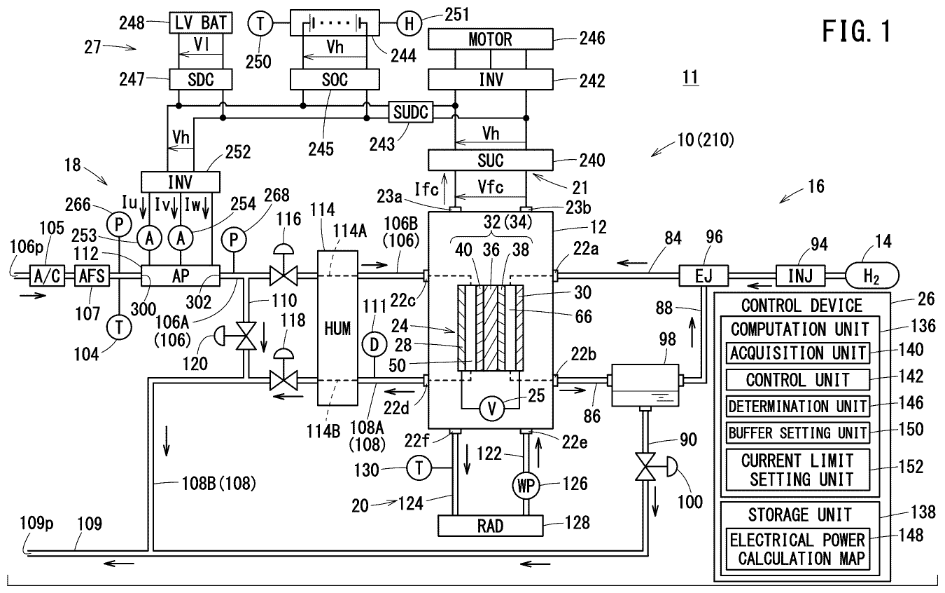

FIG. 1 is a schematic configuration diagram of a fuel cell system 10 according to the first embodiment. Here, a configuration of a fuel cell system 10 mounted on a fuel cell vehicle 11 will be described. However, the fuel cell system 10 can be mounted on any moving objects other than a vehicle. For example, the fuel cell system 10 can be mounted on a ship, an airplane, a robot, or the like, and can be used as a stationary power source in facilities, homes, and the like.

In the fuel cell system 10, a fuel gas and an oxygen-containing gas are used as reactant gases. The fuel gas is a hydrogen-containing gas. The oxygen-containing gas is a gas containing oxygen. The fuel gas and the oxygen-containing gas are individually supplied to the fuel cell stack 12 and subjected to electrochemical reactions. In the present specification, the fuel gas discharged from the fuel cell stack 12 without being consumed in the electrochemical reactions is also referred to as a fuel off-gas. Further, the oxygen-containing gas discharged from the fuel cell stack 12 without being consumed in the electrochemical reactions is referred to as an oxygen-containing off-gas.

The fuel cell system 10 includes a fuel cell stack 12, a tank 14, an anode system 16, a cathode system 18, a cooling system 20, a load 21 and a power system 27. The fuel cell system 10 includes a control device 26.

The fuel cell stack 12 includes a positive terminal 23a and a negative terminal 23b. The electrical power generated by the fuel cell stack 12 is supplied to the load 21 and the power system 27 via the positive terminal 23a and the negative terminal 23b.

The tank 14 is filled with a high-pressure fuel gas.

The fuel cell stack 12 includes a fuel gas inlet 22a and a fuel gas outlet 22b. The fuel gas is supplied to the inside of the fuel cell stack 12 through the fuel gas inlet 22a. The fuel off-gas is discharged from the inside of the fuel cell stack 12 through the fuel gas outlet 22b.

The fuel cell stack 12 includes an oxygen-containing gas inlet 22c and an oxygen-containing gas outlet 22d. The oxygen-containing gas is supplied to the inside of the fuel cell stack 12 through the oxygen-containing gas inlet 22c. The oxygen-containing off-gas is discharged from the fuel cell stack 12 through the oxygen-containing gas outlet 22d.

The fuel cell stack 12 includes a coolant inlet 22e and a coolant outlet 22f. The coolant is supplied to the inside of the fuel cell stack 12 through the coolant inlet 22e. The coolant is discharged from the inside of the fuel cell stack 12 through the coolant outlet 22f.

The anode system 16 includes a fuel gas supply path 84, a fuel gas discharge path 86, a circulation path 88, and a water discharge path 90. The anode system 16 also includes an injector 94, an ejector 96, a gas-liquid separator 98, and a water discharge valve 100.

The fuel gas supply path 84 is connected to a discharge outlet of the tank 14 and the fuel gas inlet 22a of the fuel cell stack 12. The fuel gas supply path 84 is equipped with the injector 94 and the ejector 96. The inflow port of the ejector 96 is connected to the discharge port of the injector 94, and the discharge port of the ejector 96 is connected to the fuel gas inlet 22a. The ejector 96 is disposed between the injector 94 and the fuel gas inlet 22a.

The fuel gas discharge path 86 is connected to the fuel gas outlet 22b of the fuel cell stack 12 and an inlet of the gas-liquid separator 98. The circulation path 88 is connected to a gas outlet of the gas-liquid separator 98 and the intake port of the ejector 96. The water discharge path 90 is connected to a liquid outlet of the gas-liquid separator 98 and to a discharge passage 109. The discharge passage 109 communicates with the atmosphere through a discharge outlet 109p of the fuel cell vehicle 11. The water discharge path 90 is provided with a water discharge valve 100.

The cathode system 18 includes an oxygen-containing gas supply path 106, an oxygen-containing gas discharge path 108 (discharge path), and a bypass flow path 110. The cathode system 18 includes an air cleaner 105, an air pump 112 (also referred to as an oxygen-containing gas supplier, a compressor, or simply a pump), a humidifier 114, an inlet stop valve 116, an outlet stop valve 118 that is a back pressure valve, and a bypass valve 120.

The oxygen-containing gas supply path 106 is connected to an air intake port 106p of the fuel cell vehicle 11 and to the oxygen-containing gas inlet 22c of the fuel cell stack 12. The oxygen-containing gas supply path 106 is provided with the air cleaner 105, a flow rate sensor 107, the air pump 112, the inlet stop valve 116, and an in-humidifier supply path 114A of the humidifier 114,

The oxygen-containing gas supply path 106 is referred to as an oxygen-containing gas supply path 106A on the upstream side of the humidifier 114. The oxygen-containing gas supply path 106 is referred to as an oxygen-containing gas supply path 106B on the downstream side of the humidifier 114.

The inlet stop valve 116 is disposed closer to the humidifier 114 than the air pump 112. The air cleaner 105, the flow rate sensor 107, a temperature sensor 104, and a pressure sensor 266 are attached to the oxygen-containing gas supply path 106A upstream of the air pump 112. The flow rate sensor 107 detects a flow rate Qo of the oxygen-containing gas flowing through the air pump 112. The temperature sensor 104 detects a temperature Tin of the oxygen-containing gas at an intake port 300 of the air pump 112 (inlet temperature of the air pump 112). The pressure sensor 266 detects a pressure Pin on the intake port 300 side of the air pump 112 (inlet pressure of the air pump 112). A pressure sensor 268 is provided on the oxygen-containing gas supply path 106A downstream of the air pump 112. The pressure sensor 268 detects a pressure Pout on the discharge port 302 side of the air pump 112 (outlet pressure of the air pump 112).

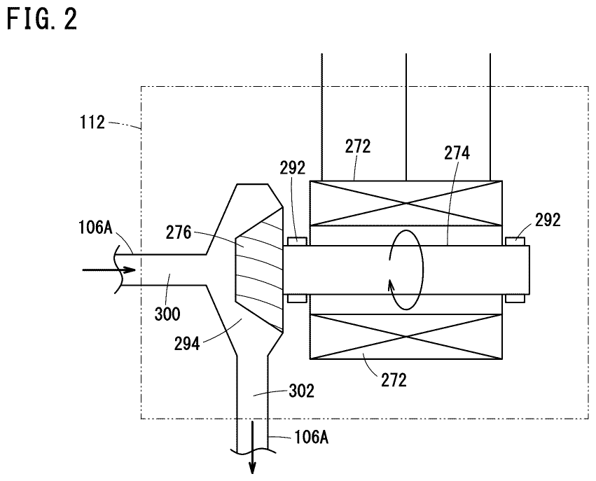

FIG. 2 is a schematic view of a turbo air pump 112 including an air bearing mechanism.

The air pump 112 has a rotor shaft 274, one end of which is fixed to an impeller 276. A plurality of magnets are embedded in the axial direction in the cylindrical side surface of the rotor shaft 274. The casing of the air pump 112 is provided with U-phase, V-phase, and W-phase stator coils 272 and bearings (also referred to as air bearings) 292. The rotor shaft 274 is inserted into the bearings 292. To the casing of the air pump 112, the flow path of the oxygen-containing gas is attached and a supercharger 294 including the impeller 276 is provided.

When the impeller 276 rotates in accordance with the rotation of the rotor shaft 274, and at a predetermined rotational speed or more, the compressed air starts to flow between the rotor shaft 274 and the inner peripheral surfaces of the bearings 292. Thus, an air layer is formed between the rotor shaft 274 and the inner peripheral surfaces of the bearings 292, and the rotor shaft 274 can stably rotate at high speed without contacting the inner peripheral surfaces of the bearings 292. This state is referred to as shaft floating of the rotor shaft 274.

During operation of the fuel cell system 10 (from the start of operation to the stop of operation), the rotor shaft 274 is preferably kept floating in order to achieve a timely response to a power generation request made to the fuel cell stack 12. The rotational speed of the air pump 112 is basically controlled at a value equal to or higher than the rotational speed at which the shaft floating of the rotor shaft 274 can be realized. That is, the rotational speed of the air pump 112 is controlled to the value equal to or higher than the minimum rotational speed at which the rotor shaft 274 can rotate without contacting the inner peripheral surfaces of the bearings 292.

Under such control, the air pump 112 takes in outside air via the intake port 300 and supercharges (pressurizes and compresses) the outside air with the supercharger 294. The air supercharged by the supercharger 294 is supplied as the oxygen-containing gas, and is discharged from the discharge port 302 to the oxygen-containing gas supply path 106A.

Returning to FIG. 1, the oxygen-containing gas discharge path 108 connects the oxygen-containing gas outlet 22d of the fuel cell stack 12 to the discharge passage 109. The oxygen-containing gas discharge path 108 is provided with an in-humidifier discharge path 114B of the humidifier 114 and the outlet stop valve 118.

The oxygen-containing gas discharge path 108 is referred to as an oxygen-containing gas discharge path 108A on the upstream side of the humidifier 114. The oxygen-containing gas discharge path 108 is referred to as an oxygen-containing gas discharge path 108B on the downstream of the humidifier 114.

A hydrogen concentration sensor 111 is attached to the oxygen-containing gas discharge path 108A. The hydrogen concentration sensor 111 is attached near the oxygen-containing gas outlet 22d. The hydrogen concentration sensor 111 detects the hydrogen concentration Dh in the oxygen-containing off-gas.

The bypass flow path 110 is connected to the oxygen-containing gas supply path 106A between the air pump 112 and the inlet stop valve 116, and to the oxygen-containing gas discharge path 108B downstream of the outlet stop valve 118. The bypass flow path 110 is provided with the bypass valve 120.

The bypass valve 120 is a butterfly valve capable of adjusting its opening degree linearly. Similarly, the inlet stop valve 116 for opening and closing the oxygen-containing gas supply path 106B and the outlet stop valve 118 for opening and closing the oxygen-containing gas discharge path 108A are butterfly valves capable of adjusting their opening degree linearly. The inlet stop valve 116 and the outlet stop valve 118 may be valves that switch between ON (100% opening degree) and OFF (0% opening degree), such as solenoid valves.

The cooling system 20 includes a coolant supply path 122 and a coolant discharge path 124. The cooling system 20 includes a water pump 126 and a radiator 128. The coolant supply path 122 is connected to a fluid outlet of the radiator 128 and the coolant inlet 22e of the fuel cell stack 12. The coolant supply path 122 is provided with the water pump 126.

The coolant discharge path 124 is connected to the coolant outlet 22f of the fuel cell stack 12 and a fluid inlet of the radiator 128. The temperature sensor 130 is attached to the coolant discharge path 124. The temperature sensor 130 detects the temperature of the coolant flowing through the coolant discharge path 124. The temperature of the coolant flowing through the coolant discharge path 124 corresponds to the temperature inside the fuel cell stack 12 (stack temperature).

The fuel cell stack 12 is formed by stacking a plurality of electrical power generation cells 24. Each of the electrical power generation cells 24 is equipped with a membrane electrode assembly 32, and separators 28, 30 that sandwich the membrane electrode assembly 32 therebetween. The membrane electrode assembly 32 includes a membrane electrode assembly (MEA) 34 and a resin frame member (not shown) surrounding the outer periphery of the MEA.

The MEA 34 is equipped, for example, with a thin film (solid polymer electrolyte membrane) 36 of perfluorosulfonic acid containing water, and a cathode 40 and an anode 38 that sandwich the thin film 36 therebetween. The cathode 40 and the anode 38 respectively include an electrode catalyst layer (not shown) and a gas diffusion layer (not shown) made of carbon paper or the like. The electrode catalyst layer includes porous carbon particles with platinum alloy supported on surfaces thereof. The porous carbon particles are uniformly coated together with the ion conductive polymer binder on the surface of the gas diffusion layer. Thus, an electrode catalyst layer is formed. The electrode catalyst layer is formed on both sides of the thin film (solid polymer electrolyte membrane) 36.

A cathode flow field (oxygen-containing gas flow field) 50 is formed on a surface of one separator 28 facing the membrane electrode assembly 32. The oxygen-containing gas inlet 22c communicates with the oxygen-containing gas outlet 22d through the cathode flow field 50. The pressure of the oxygen-containing gas flowing through the cathode flow field 50 is controlled by the opening degree of the outlet stop valve 118 adjusted by the control device 26.

An anode flow field (fuel gas flow field) 66 is formed on a surface of the other separator 30 facing the membrane electrode assembly 32. The fuel gas inlet 22a communicates with the fuel gas outlet 22b through the anode flow field 66.

The fuel gas is supplied to the anodes 38. At the anodes 38, hydrogen ions are generated and electrons are released from hydrogen molecules by electrode reactions caused by catalyst. The hydrogen ions pass through the MEA 34 and move to the cathode 40, while the electrons that are released from the hydrogen molecules move from the separator 30 and the negative terminal 23b through the load 21 to the cathode 40 via the positive terminal 23a and the separator 28.

The oxygen-containing gas (oxygen) is supplied to the cathodes 40. At the cathodes 40, by action of the catalyst, hydrogen ions and electrons react with oxygen contained in the oxygen-containing gas as supplied, in order to produce water.

A cell voltage sensor 25 is attached to each of the power generation cells 24. The cell voltage sensor 25 detects a cell voltage Vcell which is a voltage between terminals of one power generation cell 24 (unit cell).

The load 21 includes a motor 246 and the air pump (auxiliary electrical device) 112 as high-voltage loads, and a battery heater 251 and an air conditioner (not shown) as low-voltage loads. The motor 246 is a driving source of the fuel cell vehicle 11, and the fuel cell vehicle 11 travels due to a driving force generated by the motor 246. The air pump 112 supplies the oxygen-containing gas toward the fuel cell stack 12. The battery heater 251 heats a power storage device 244.

The power system 27 includes a power storage device (battery) 248 functioning as a low-voltage power supply that generates a low voltage Vl and a power storage device (battery) 244 functioning as a high-voltage power supply that generates a high voltage Vh. In this embodiment, a lead-acid storage battery is used as the power storage device (hereinafter, also simply referred to as a power source) 248. A lithium ion secondary battery or the like may be used instead of the lead-acid storage battery. In this embodiment, a lithium ion secondary battery is used as the power storage device 244. A capacitor or the like may be used instead of the lithium ion secondary battery.

The power storage device 244 is configured to be able to charge and discharge electrical power, and discharges electrical power in an amount making up for the shortage of the electrical power generated by the fuel cell stack 12 with respect to the electrical power actually consumed by the motor 246 and the air pump 112 (hereinafter, also referred to as actual AP power consumption) during motoring. The power storage device 244 is charged with electrical power regenerated by the motor 246 during regeneration. The power storage device 244 charges the surplus of the electrical power generated by the fuel cell stack 12 with respect to the actual AP power consumption of the air pump 112.

A temperature sensor (temperature measurement device) 250, a charged amount detection sensor (SOC sensor) 245, and the battery heater 251 are attached to the power storage device 244. The temperature sensor 250 detects a temperature That of the power storage device 244, and outputs the temperature to the control device 26.

The charged amount detection sensor 245 detects the SOC {state of charge [%]=(remaining capacity at present)/(full charge capacity)×100} of the power storage device 244, and outputs the SOC to the control device 26. The SOC [%] is a remaining capacity with respect to the full charge capacity, and the charged amount detection sensor 245 calculates the SOC [%] from the temperature That, the input/output current (charging/discharging current), and the voltage of the power storage device 244.

The charged amount detection sensor 245 calculates a discharging limit Dlim [kWh] and a charging limit Clim [kWh] according to the calculated SOC. The discharging limit Dlim is a threshold for protecting the power storage device 244 from being placed in a state of excessive discharging, and the charging limit Clim is a threshold for protecting the power storage device 244 from being placed in a state of excessive charging.

The discharging limit Dlim and the charging limit Clim can be calculated based on the temperature That, the input/output current (charging/discharging current), the voltage, the internal resistance of the power storage device 244, and the like, in addition to the SOC of the power storage device 244. The discharging limit Dlim and the charging limit Clim may be calculated by the control device 26 instead of the charged amount detection sensor 245.

The charged amount detection sensor 245 notifies the control device 26 of the calculated discharging limit Dlim and charging limit Clim. The control device 26 utilize a step-up/step-down converter 243 to avoid the power storage device 244 from being placed in a range exceeding the discharging limit Dlim and the charging limit Clim. In other words, the control device 26 uses the power storage device 244 within a limited range of charging and discharging (range of amount of electrical power) 68 between the discharging limit Dlim and the charging limit Clim.

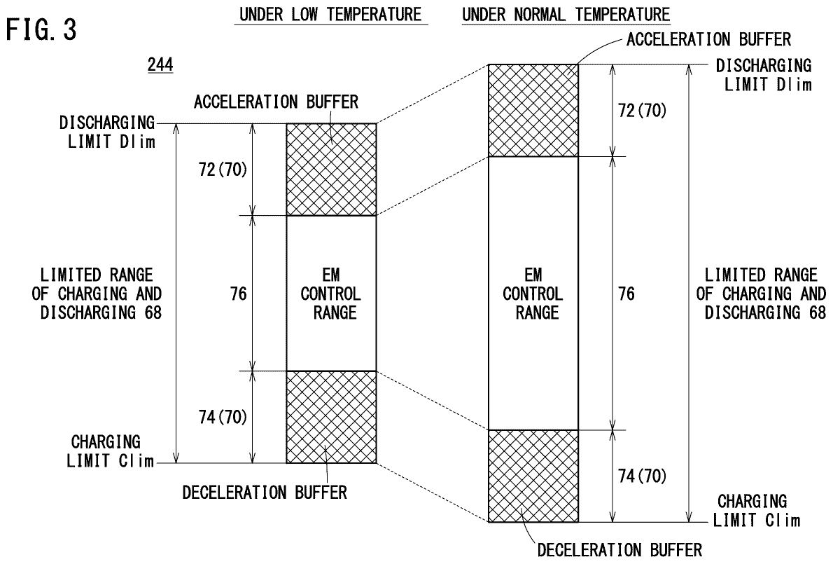

FIG. 3 is an explanatory diagram for explaining the limited range of charging and discharging 68 of the power storage device 244. The limited range of charging and discharging 68 may vary in its entire size depending on the temperature That of the power storage device 244. In general, the size of the limited range of charging and discharging 68 is smaller under low temperature (including extremely low temperature (for example, less than 0° C.)) than at normal temperatures. The charged amount detection sensor 245 monitors the limited range of charging and discharging 68 constantly and notifies the control device 26 of the limited range of charging and discharging 68.

As shown in FIG. 3, a buffer (also referred to as a margin) 70 for the air pump 112 is set within the limited range of charging and discharging 68 of the power storage device 244. The buffer 70 includes an acceleration buffer (discharge margin) 72 set in relation to the discharging limit Dlim and a deceleration buffer (charge margin) 74 set in relation to the charging limit Clim.

The acceleration buffer 72 allows instant electrical power consumption by acceleration of the rotational speed of the air pump 112, shortage of FC generated electrical power, and transient fluctuations of electrical power. For example, in the case where the air pump 112 runs short of electrical power, the power storage device 244 discharges electrical power to the air pump 112 in an amount corresponding to the shortage within the range of the acceleration buffer 72. The acceleration of the rotational speed of the air pump 112 means that the rate of change [rpm/see] of rotational speed [rpm] of the air pump 112 per time is positive.

On the other hand, the deceleration buffer 74 allows instant oversupply of electrical power by deceleration of the rotational speed of the air pump 112, a surplus of FC generated electrical power, a surplus of electrical power due to regenerative electrical power of the air pump 112 and regenerative electrical power of the motor 246, and transient fluctuations of electrical power. For example, in the case where electrical power is left over at the air pump 112, the power storage device 244 charges the surplus electrical power within the range of the deceleration buffer 74. The deceleration of the rotational speed of the air pump 112 means that the rate of change [rpm/see] of rotational speed [rpm] of the air pump 112 per time is negative.

As a result, the buffer 70 (the acceleration buffer 72 and the deceleration buffer 74) absorbs rapid fluctuations of the actual AP power consumption at the time of acceleration and deceleration of the rotational speed of the air pump 112, and protects the power storage device 244 from being placed in a state of excessive charging or discharging.

The size of electrical power range of the buffer 70 can be set based on, for example, the discharging limit Dlim and the charging limit Clim calculated by the charged amount detection sensor 245 and the temperature That of the power storage device 244. The control device 26 may calculate the size of electrical power range of the buffer 70 using a buffer calculation map (not shown) stored in advance in the storage unit 138 of the control device 26. The size of electrical power range of the buffer 70 is also simply referred to as a buffer width.

In the fuel cell system 10 according to the present embodiment, the amount of electrical power of the acceleration buffer 72 can be changed (varied) within the size of electrical power range (buffer width) of the buffer 70. The minimum amount (required minimum amount) of the acceleration buffer 72 may be set, for example, based on the amount of electrical power required to rotate the air pump 112 at the minimum rotational speed (the minimum value of the rotational speed required for the rotor shaft 274 of the air pump 112 to float). The maximum amount (maximum required amount) of the acceleration buffer 72 may be set, for example, based on the amount of electrical power required to rotate the air pump 112 at the maximum acceleration rate (the positive maximum value of the rate of change in the rotational speed per time).

Similarly, the amount of electrical power of the deceleration buffer 74 can be changed (varied) within the size of electrical power range (buffer width) of the buffer 70. The minimum amount (required minimum amount) of the deceleration buffer 74 can be set, for example, in consideration of variations in measurement error of the flow rate sensor 107, quantity error of electrical power of the inverter 252. The maximum amount (required maximum amount) of the deceleration buffer 74 can be set based on the maximum deceleration rate (the negative maximum value of the rate of change in the rotational speed per time) of the air pump 112 that can avoid drying of the fuel cell stack 12 when the output of the fuel cell stack 12 is reduced.

In the limited range of charging and discharging 68 shown in FIG. 3, a range other than the acceleration buffer 72 and the deceleration buffer 74 is referred to as an energy management control range (EM control range) 76. The electrical power in the EM control range 76 is assigned for charging and discharging the load 21 other than the air pump 112. The load 21 other than the air pump 112 includes the motor 246, the battery heater 251, the air conditioner (not shown), and the like.

Returning to FIG. 1, the motor 246 is connected to the inverter 242. The inverter 242 is supplied with electrical power of a high voltage Vh from the fuel cell stack 12 via a step-up converter 240 and from the power storage device 244 via the step-up/step-down converter 243. That is, the motor 246 is supplied with electrical power from one or both of the fuel cell stack 12 and the power storage device 244. The inverter 242 converts high voltage direct current supplied from one or both of the fuel cell stack 12 and the power storage device 244 into a three-phase alternating current to drive the motor 246.

The power storage device 244 is charged with electrical energy generated by the fuel cell stack 12. The step-up converter 240 boosts generated voltages Vfc of the fuel cell stack 12 to direct current high voltages Vh, and the boosted high voltages Vh are applied to the power storage device 244 via the step-up/step-down converter 243.

While the fuel cell vehicle 11 is being decelerated and the motor 246 is in a regenerative mode, the motor 246 functions as a generator. The inverter 242 converts the regenerative voltage at the motor 246 into direct current high voltage Vh, and then the direct current high voltage Vh is applied to a high-voltage end of the step-up/step-down converter 243. The regenerative electrical energy supplied to the high-voltage end is supplied to the power storage device 244 through the low-voltage end of the step-up/step-down converter 243 to charge the power storage device 244.

The low-voltage loads include the control device 26, various sensors, the battery heater 251, the air conditioner, an electrical power steering device, a lighting device, and the like (not shown). These low-voltage loads are supplied with electrical power of a low direct voltage Vl from the power source 248. The power source 248 is charged with electrical power of the low voltage Vl stepped down by a step-down converter 247 from the high voltage Vh supplied from the power storage device 244.

The air pump 112 is supplied with electrical power of three phase alternating current from the inverter 252. The inverter 252 converts the direct current high voltage Vh supplied from the power storage device 244 into three phase alternating current voltage. The inverter 252 supplies the converted three phase alternating current to the air pump 112, and drives the air pump 112 within the range of the rated electrical power. The rated electrical power of the air pump 112 is, for example, the maximum electrical power with which the air pump 112 can stably operate, and is set in advance according to the specifications of the air pump 112. Two arbitrary phases of the three phase alternating current, a U-phase alternating current Iu and a V-phase alternating current Iv herein, are detected by a current sensor 253 and a current sensor 254, respectively.

It should be noted that when the air pump 112 is driven by the electrical power generated by the fuel cell stack 12, the electrical power generated by the fuel cell stack 12 is not directly supplied to the air pump 112. In this case, the power storage device 244 is charged with electrical power generated by the fuel cell stack 12 through the step-up/step-down converter 243, and then the air pump 112 is supplied with electrical power from the power storage device 244 through the inverter 252.

A power switch (a driving switch or an ignition switch) (not shown) is connected to the control device 26. The user starts or stops operation (power generation) of the fuel cell vehicle 11 (fuel cell system 10) via the power switch.

The power switch put in an ON state allows the fuel cell stack 12 to generate electrical power to bring the fuel cell vehicle 11 into a travelable state or a traveling state. The travelable state of the fuel cell vehicle 11 refers to a state in which the fuel cell stack 12 is in an idle power generation state with small electrical power generated and the fuel cell vehicle 11 is not traveling. When the power switch is turned off, the power generation operation of the fuel cell stack 12 is terminated, and the fuel cell vehicle 11 is placed into an out-of-operation state (non-operation state).

The control device 26 is constituted by an ECU (Electronic Control Unit). The control device 26 includes a computation unit 136 and a storage unit 138. The computation unit 136 is, for example, a processor such as a central processing unit (CPU) or a graphics processing unit (GPU). More specifically, the computation unit 136 can be configured by a processing circuit (processing circuitry). The computation unit 136 controls each device by executing a computer-executable instructions (program) stored in the storage unit 138. At least a portion of the computation unit 136 may be realized by an integrated circuit such as an ASIC (Application Specific Integrated Circuit), an FPGA (Field-Programmable Gate Array), or the like. Further, at least a portion of the computation unit 136 may be constituted by an electronic circuit including a discrete device.

The computation unit 136 includes an acquisition unit 140, a control unit 142, a time measurement unit (not shown), a determination unit 146, a buffer setting unit 150 and a current limit setting unit 152. The acquisition unit 140 acquires information from electronic components (sensors, ECUs, and the like) other than the control device 26.

The sensors include sensors not shown in the drawings in addition to the cell voltage sensor 25, the temperature sensor 104, the flow rate sensor 107, the hydrogen concentration sensor 111, the temperature sensor 130, the current sensor 253, the current sensor 254, the pressure sensor 266, the pressure sensor 268, the charged amount detection sensor 245, and the temperature sensor 250 shown in FIG. 1. For example, such sensors include a voltage sensor for detecting the generated voltage Vic of the fuel cell stack 12, a current sensor for detecting the generated current Ifc of the fuel cell stack 12, a voltage sensor for detecting the high voltage Vh of the power storage device 244, a voltage sensor for detecting the low voltage Vl of the power source 248, and a flow rate sensor for detecting the flow rate of the oxygen-containing gas in the fuel cell stack 12.

The control unit 142 executes computer-executable instructions (programs) based on various signals acquired from the sensors through the acquisition unit 140. The control unit 142 controls operations of the injector 94, the air pump 112, the water pump 126, the motor 246, the step-up converter 240, the inverter 242, the inverter 252, the step-up/step-down converter 243, the step-down converter 247, the valves, and the like. The time measurement unit measures by a non-illustrated timer the implementation time. The determination unit 146 determines suitability of the buffer 70 of the power storage device 244. The buffer setting unit 150 sets the buffer 70 of the power storage device 244. The current limit setting unit 152 sets an upper limit of the current output from the fuel cell stack 12 (hereinafter, also referred to as an FC current limit).

The storage unit 138 may be made up of a volatile memory (not shown), and a non-volatile memory (not shown), as a computer-readable storage medium. At least a portion of the storage unit 138 may be provided in the processor, the integrated circuit, or the like, which have been described above.

Examples of the volatile memory include, for example, a RAM (Random Access Memory) or the like. Data, etc. may be recorded in the volatile memory, for example. The physical quantities acquired by the control device 26 from the various sensors, the calculated values including the discharging limit Dlim and the charging limit Clim, and the like are recorded in the volatile memory.

As the non-volatile memory, there may be cited, for example, a ROM (Read Only Memory), a flash memory, or the like. Programs, tables, maps, and the like are stored, for example, in the non-volatile memory. The non-volatile memory stores an electrical power calculation map 148 that enables calculation of the steady power consumption of the air pump 112 (steady AP power consumption). In addition, a buffer calculation map (not shown) and an air pump system efficiency map (not shown) are recorded in the non-volatile memory.

The steady AP power consumption of the air pump 112 is the electrical power consumed by the air pump 112 in a state where the air pump 112 is rotating at certain rotational speeds [rpm] (steady state) and the fuel cell stack 12 generates electrical power stably. The steady AP power consumption is recorded in advance in the electrical power calculation map 148 for each predetermined rotational speed. The control unit 142 can acquire the rotational speed of the air pump 112, refer to the electrical power calculation map 148 for the acquired rotational speed, and calculate the corresponding steady AP power consumption.

The steady AP power consumption may be calculated from the theoretical thermodynamic work [W] of the compressor (air pump 112) and the air pump system efficiency [%]. The air pump system efficiency may be calculated from the air pump system efficiency map.

The air pump system efficiency map records in advance the air pump system efficiency [%] corresponding to the flow rate Qo of the oxygen-containing gas and the pressure ratio of the air pump 112. The pressure ratio of the air pump 112 is calculated as a ratio between the inlet pressure Pin of the air pump 112 detected by the pressure sensor 266 and the outlet pressure Pout of the air pump 112 detected by the pressure sensor 268. The control unit 142 calculates the air pump system efficiency from the flow rate Qo of the oxygen-containing gas and the pressure ratio of the air pump 112 with reference to the air pump system efficiency map.

As for the flow rate Qo of the oxygen-containing gas, a value obtained by correcting the measured value of the flow rate sensor 107 may be used instead of the measured value of the flow rate sensor 107. The control unit 142 can correct the measurement value of the flow rate sensor 107 in consideration of, for example, the specifications of the air pump 112 and the pressure loss inside the air pump 112. In the case of correcting the measurement value of the flow rate sensor 107, the inlet temperature Tin of the air pump 112, the inlet pressure Pin of the air pump 112, or other values may be further considered.

The control device 26 acquires changes in the U-phase alternating current Iu and the V-phase alternating current Iv detected by the current sensors 253, 254 through the acquisition unit 140 so that the control unit 142 can calculate the rotational speed of the air pump 112.

The control device 26 performs feedback control by vector control on the three phase alternating currents supplied from the inverter 242 to the motor 246 and the three phase alternating currents Iu, Iv, and Iw supplied from the inverter 252 to the air pump 112 based on a torque command value of the motor 246.

The control device 26 calculates the electrical power actually consumed by the air pump 112 (actual AP power consumption) from the terminal direct voltage of the air pump 112 and the three phase alternating current detected by the current sensors 253, 254.

### Difference Between Actual AP Power Consumption and Steady AP Power Consumption

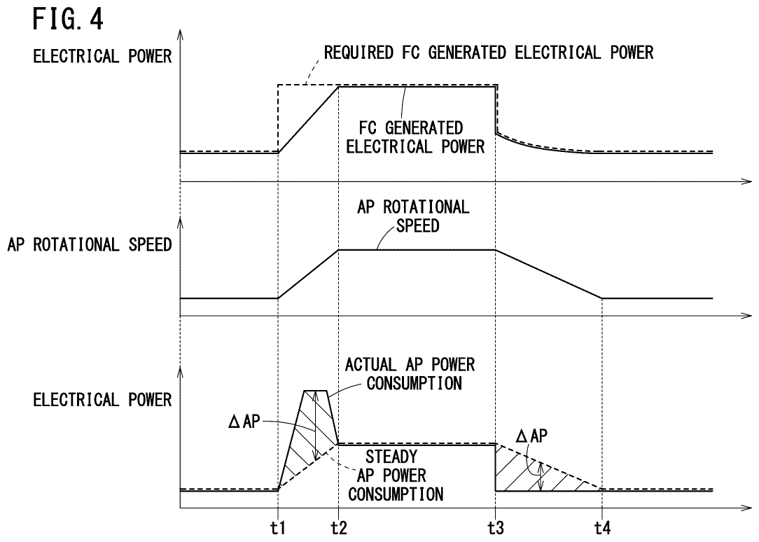

Here, the difference between the actual AP power consumption and the steady AP power consumption will be described. FIG. 4 is a timing chart showing an example of a relationship between actual AP power consumption and steady AP power consumption of the air pump 112.

In the fuel cell system 10, the electrical power required by the load 21 of the fuel cell vehicle 11 is basically provided from the electrical power generated by the fuel cell stack 12. The control device 26 calculates the electrical power consumed by the entire fuel cell vehicle 11. Hereinafter, the electrical power consumed by the entire fuel cell vehicle 11 is referred to as a vehicle required electrical power. The control device 26 calculates a target generated electrical power of the FC (required FC generated electrical power) according to the vehicle required electrical power. The control device 26 calculates a target rotational speed of the air pump 112 from the flow rate Qo of the oxygen-containing gas and the pressure ratio (the ratio of the inlet pressure Pin of the air pump 112 to the outlet pressure Pout of the air pump 112) corresponding to the required FC generation power. The control device 26 calculates the steady AP power consumption from the target rotational speed with reference to the electrical power calculation map 148. The calculated steady AP power consumption is fed back to the next calculation of the vehicle required electrical power as the electrical power required for driving the air pump 112.

From time t2 to time t3 in FIG. 4, the fuel cell stack 12 stably generates a certain amount of electrical power (FC generated power), and the air pump 112 is driven at a certain rotational speed. In this case, the actual AP power consumption and the steady AP power consumption substantially coincide with each other.

However, when the air pump 112 is accelerated or decelerated, a difference may occur between the actual AP power consumption and the steady AP power consumption.

The period from time t1 to time t2 in FIG. 4 indicates the acceleration of the rotational speed of the air pump 112. The amount of electrical power generated by the fuel cell stack 12 (FC generated power) increases, and the rotational speed of the air pump 112 increases. In this case, the increase in the electrical power supplied to the air pump 112 by the fuel cell stack 12 (steady AP power consumption) cannot catch up with the increase in the actual AP power consumption, and the actual AP power consumption becomes larger than the steady AP power consumption. In this specification, the difference between the actual AP power consumption and the steady AP power consumption in the transient operation of the air pump 112 (=actual AP power consumption-steady AP power consumption) is referred to as “Δ AP”.

While the rotational speed of the air pump 112 is being accelerated, the power storage device 244 discharges the electrical power corresponding to ΔAP to compensate for the shortage of the FC generated power. By providing in advance the limited range of charging and discharging 68 with the acceleration buffer 72 allowing discharging, the power storage device 244 can absorb instant increase in power consumption and power shortage associated with acceleration of the rotational speed of the air pump 112.

The period from time t3 to time t4 in FIG. 4 indicates the deceleration of the rotational speed of the air pump 112. The amount of electrical power generated by the fuel cell stack 12 (FC generated power) decreases, and the rotational speed of the air pump 112 decreases. In this case, the decrease in the electrical power supplied to the air pump 112 by the fuel cell stack 12 (steady AP power consumption) cannot catch up with the decrease in the actual AP power consumption, and the actual AP power consumption becomes smaller than the steady AP power consumption.

While the rotational speed of the air pump 112 is being decelerated, the power storage device 244 is charged with the electrical power corresponding to ΔAP to absorb the surplus of the FC generated power. By providing in advance the limited range of charging and discharging 68 with the deceleration buffer 74 allowing charging, the power storage device 244 can absorb an instant increase in generated power in oversupply and surplus electrical power associated with deceleration of the rotational speed of the air pump 112.

### Fluid Flow in Fuel Cell System 10

### 1. Fluid Flow in Anode System 16

The injector 94 injects the fuel gas supplied from the tank 14, toward the downstream side of the fuel gas supply path 84 under Pulse Width Modulation (PWM) control by the control device 26. The fuel gas injected by the injector 94 is supplied to the fuel gas inlet 22a of the fuel cell stack 12 through the fuel gas supply path 84. The unreacted fuel gas in the fuel cell stack 12 is discharged as a fuel off-gas from the fuel gas outlet 22b of the fuel cell stack 12. The fuel off-gas contains hydrogen that has not reacted with oxygen and nitrogen that had been contained in the oxygen-containing gas and has permeated through the thin film (solid polymer electrolyte membrane) 36.

At the cathode 40, water is produced by the reactions between oxygen and hydrogen, and the produced water partially passes through the thin film (solid polymer electrolyte membrane) 36 and moves to the anode 38 side. The fuel off-gas contains not only hydrogen and nitrogen but also water that has passed through the thin film (solid polymer electrolyte membrane) 36 and moved to the anode electrode 38 side.

The fuel off-gas is supplied to the gas-liquid separator 98 via the fuel gas discharge path 86. The gas-liquid separator 98 separates the fuel off-gas into a gaseous component (fuel off-gas) and a liquid component (liquid water). The fuel off-gas discharged from the gas-liquid separator 98 flows through the circulation path 88 and is supplied to the ejector 96. The fuel off-gas introduced into the ejector 96 from the gas-liquid separator 98 is mixed with the fuel gas that is injected by the injector 94.

### 2. Fluid Flow in Cathode System 18

The air pump 112 compresses the oxygen-containing gas (air) taken from the outside of the fuel cell vehicle 11, and discharges the compressed oxygen-containing gas toward the downstream side of the oxygen-containing gas supply path 106. The oxygen-containing gas discharged from the air pump 112 is supplied to the oxygen-containing gas inlet 22c of the fuel cell stack 12 through the oxygen-containing gas supply path 106 equipped with a cooler (not shown). The unreacted oxygen-containing gas in the fuel cell stack 12 is discharged as an oxygen-containing off-gas from the oxygen-containing gas outlet 22d of the fuel cell stack 12. The oxygen-containing off-gas contains components contained in the oxygen-containing gas and water generated by the reactions between oxygen and hydrogen.

The oxygen-containing off-gas is discharged to the outside of the fuel cell vehicle 11 through the oxygen-containing gas discharge path 108. The oxygen-containing off-gas contains water. In the humidifier 114, a part of the water contained in the oxygen-containing off-gas is used for humidifying the oxygen-containing gas flowing through the in-humidifier supply path 114A.

In the cathode system 18, the inlet stop valve 116 may be fully closed, and the bypass valve 120 may be fully opened. In this case, the oxygen-containing gas discharged from the air pump 112 flows into the bypass flow path 110 without flowing into the oxygen-containing gas supply path 106B. The oxygen-containing gas flowing through the bypass flow path 110 is discharged to the outside of the fuel cell vehicle 11 through the oxygen-containing gas discharge path 108.

### 3. Fluid Flow in Cooling System 20

The water pump 126 discharges the coolant toward the coolant inlet 22e of the fuel cell stack 12. The coolant discharged from the water pump 126 is supplied to the coolant inlet 22e of the fuel cell stack 12 through the coolant supply path 122. The coolant that has flowed through the fuel cell stack 12 is discharged from the coolant outlet 22f of the fuel cell stack 12. The coolant discharged from the coolant outlet 22f is supplied to the radiator 128 via the coolant discharge path 124. The coolant that has radiated heat in the radiator 128 is sucked in by the water pump 126.

### Setting of Acceleration Buffer

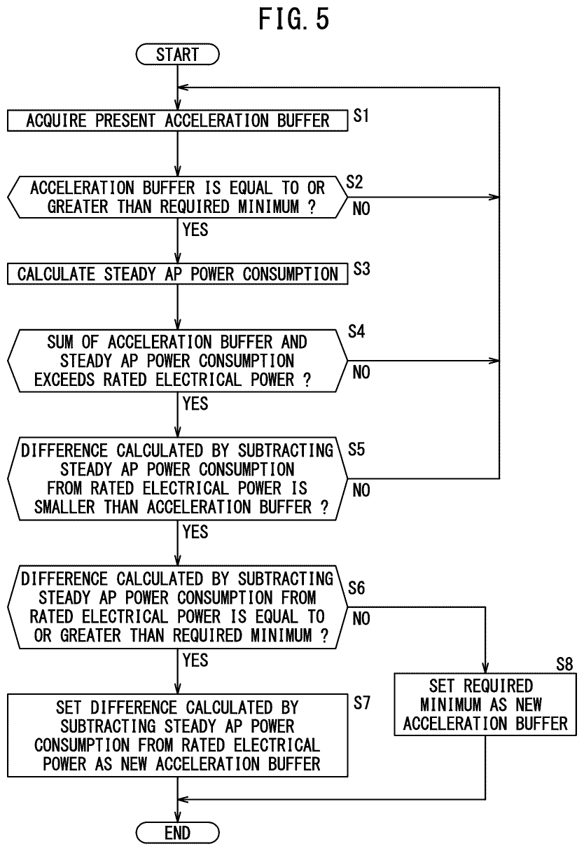

The fuel cell system 10 according to the first embodiment is basically configured in the manner described above. Next, a flow in which the control device 26 sets the size of electrical power of the acceleration buffer 72 of the power storage device 244 at the time of acceleration of the rotational speed of the air pump 112 will be described with reference to the flowchart of FIG. 5.

In the flowchart of FIG. 5, the power switch is turned on in the initial state. The fuel cell stack 12 has started or continued the power generation operation, and the fuel cell vehicle 11 is in a travelable state or a traveling state. The acceleration buffer 72 is initially set to the maximum amount (required maximum amount).

As shown in FIG. 5, in step S1, the acquisition unit 140 of the control device 26 acquires the present acceleration buffer 72 from the charged amount detection sensor 245. In step S2, the determination unit 146 determines whether the acquired acceleration buffer 72 is equal to or larger than the required minimum amount. Since the acceleration buffer 72 is initially set to the maximum amount (the maximum required amount), the determination unit 146 may determine that the acquired acceleration buffer 72 is equal to or larger than the required minimum amount (YES in step S2). Therefore, the process proceeds to step S3.

Under a situation where the SOC of the power storage device 244 is very small, such as under low temperature, it can be determined that the acquired acceleration buffer 72 is smaller than the required minimum amount (step S2: NO). In this case, the process returns to step S1, and waits for the temperature rise and the SOC recovery of the power storage device 244.

In step S3, the computation unit 136 calculates the steady AP power consumption from the rotational speed of the air pump 112 and the electrical power calculation map 148. In step S4, the computation unit 136 adds the acceleration buffer 72 and the steady AP power consumption. The determination unit 146 determines whether or not the value obtained by adding the acceleration buffer 72 and the steady AP power consumption (the sum of the acceleration buffer 72 and the steady AP power consumption) exceeds the rated electrical power of the air pump 112.

In step S4, when the amount obtained by adding the acceleration buffer 72 and the steady AP power consumption does not exceed the rated electrical power of the air pump 112 (step S4: NO), the process returns to step S1 without correcting the acceleration buffer 72.

In step S4, when the amount obtained by adding the acceleration buffer 72 and the steady AP power consumption exceeds the rated electrical power of the air pump 112 (step S4: YES), there is a possibility that the acceleration buffer 72 larger than necessary is allocated in the power storage device 244. This is because the air pump 112 is driven within the range of the rated electrical power.

In step S5, the computation unit 136 subtracts the steady AP power consumption from the rated electrical power of the air pump 112, and the determination unit 146 determines whether the difference is smaller than the acceleration buffer 72.

In step S5, when the difference obtained by subtracting the steady AP power consumption from the rated electrical power of the air pump 112 is equal to or larger than the acceleration buffer 72 (step S5: NO), the determination unit 146 determines that the range set as the acceleration buffer 72 is appropriate. The control device 26 returns to step S1 without correcting the acceleration buffer 72.

In step S5, when the difference obtained by subtracting the steady AP power consumption from the rated electrical power of the air pump 112 is smaller than the acceleration buffer 72 (step S5: YES), the process proceeds to step S6.

In step S6, the determination unit 146 determines whether or not the difference obtained by subtracting the steady AP power consumption from the rated electrical power is equal to or larger than the required minimum amount of the acceleration buffer 72.

In step S6, when the difference obtained by subtracting the steady AP power consumption from the rated power is equal to or larger than the required minimum amount of the acceleration buffer 72 (step S6: YES), the process proceeds to step S7. In step S7, the buffer setting unit 150 corrects the acceleration buffer 72, and sets the difference obtained by subtracting the steady AP power consumption from the rated electrical power as the new acceleration buffer 72. Thus, a proper amount of electrical power is allocated to the acceleration buffer 72.

In step S6, when the difference obtained by subtracting the steady AP power consumption from the rated electrical power is smaller than the required minimum amount of the acceleration buffer 72 (step S6: NO), the process proceeds to step S8. In step S8, the buffer setting unit 150 corrects the acceleration buffer 72 and sets the required minimum amount of the acceleration buffer 72 as the new acceleration buffer 72.

### Operation Explanation Using Timing Chart

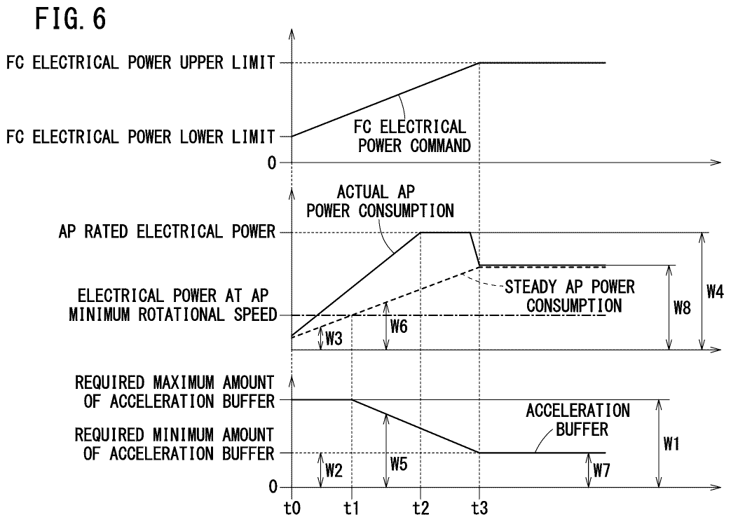

An example of the operations described with reference to the flowchart of FIG. 5 will be described with reference to the timing chart of FIG. 6 while avoiding repeated explanations on the operations.

Before time to in FIG. 6, the fuel cell system 10 (fuel cell stack 12) is generating electrical power. In this initial state, the air pump 112 rotates at the minimum rotational speed which enables the rotor shaft 274 to float.

At time to, the control device 26 receives or calculates a target generated power of the fuel cell stack 12 (FC electrical power command). When the control device 26 instructs the air pump 112 to rotate at a target rotational speed, the air pump 112 starts to accelerate its rotational speed and the actual AP power consumption and the steady AP power consumption start to increase.

From time to t0 time t1, the acceleration buffer 72 is in the maximum amount (maximum required amount) W1, which is equal to or larger than the required minimum amount W2 (step S2: YES). The amount obtained by adding the acceleration buffer W1 and the steady AP power consumption W3 does not exceed the rated electrical power W4 of the air pump 112 (step S4: NO). Therefore, the control device 26 maintains the acceleration buffer W1 without correction.

From time t1 to time t3, the amount obtained by adding the acceleration buffer W5 and the steady AP power consumption W6 exceeds the rated electrical power W4 of the air pump 112 as the steady AP power consumption W6 increases (step S4: YES). The difference obtained by subtracting the steady AP power consumption W6 from the rated electrical power W4 is smaller than the acceleration buffer W5 (step S5: YES). On the other hand, the difference obtained by subtracting the steady AP power consumption W6 from the rated electrical power W4 is equal to or larger than the required minimum amount W2 of the acceleration buffer 72 (YES in step S6). The control device 26 corrects the acceleration buffer W5, and sets the difference obtained by subtracting the steady AP power consumption W6 from the rated electrical power W4 as the new acceleration buffer 72 (step S7). That is, the control device 26 decreases the acceleration buffer 72 in accordance with the increase in the steady AP power consumption from time t1 to time t3.

In this way, the control device 26 sets the acceleration buffer 72 based on the steady AP power consumption and the rated electrical power of the air pump 112. The control device 26 secures the acceleration buffer 72 in a range necessary for driving the air pump 112 with respect to the limited range of charging and discharging 68 of the power storage device 244. On the other hand, the control device 26 does not set aside an excessive (unnecessary) amount of electrical power that is not requested to drive the air pump 112, as the acceleration buffer 72. Therefore, the energy management control range (EM control range shown in FIG. 3) 76 that can be used by the load 21 other than the air pump 112 can be expanded.

The control device 26 controls the amount obtained by adding the acceleration buffer 72 and the steady AP power consumption not to exceed the rated electrical power of the air pump 112. Therefore, the control device 26 can accurately allocate an amount just required for driving the air pump 112 to the acceleration buffer 72 with respect to the limited range of charging and discharging 68.

At time t2, the actual AP power consumption reaches the rated electrical power W4, and the actual AP power consumption substantially matches the rated electrical power W4 during the period from time t2 to time t3. At time t3, the acceleration buffer 72 reaches the required minimum amount W2.

At time t3, the actual AP power consumption substantially matches the steady AP power consumption. Thus, after time t3, the fuel cell stack 12 stably generates electrical power in accordance with the FC electrical power command. The air pump 112 rotates at a certain rotational speed at which the fuel cell stack 12 can output the target generated power. That is, the air pump 112 reaches a constant state. In this case, the amount obtained by adding the acceleration buffer W7 and the steady AP power consumption W8 does not exceed the rated electrical power W4 of the air pump 112 (step S4: NO). The difference obtained by subtracting the steady AP power consumption W8 from the rated electrical power W4 is the acceleration buffer W7. The acceleration buffer W7 substantially matches the required minimum amount W2 of the acceleration buffer 72. The control device 26 maintains the required minimum amount W2 as the acceleration buffer 72.

The steady AP power consumption may not be calculated based on the rotational speed of the air pump 112 and the electrical power calculation map 148. The calculation method may be any known method as long as the estimated amount of the electrical power supplied from the fuel cell stack 12 to the air pump 112 can be calculated.

The rated electrical power of the air pump 112 may be replaced with another quantity. In the flow of setting the acceleration buffer 72, any value larger than the steady AP power consumption at the maximum rotational speed rate of the air pump 112 will suffice. The rated electrical power may be replaced with a larger or smaller value depending on the specifications of the air pump 112 and the fuel cell stack 12.

### Second Embodiment

Next, a fuel cell system 210 according to a second embodiment will be described. In the first embodiment, the limited range of charging and discharging 68 of the power storage device 244 is optimized by allocating a buffer width that is just enough to drive the air pump 112 to the acceleration buffer 72. In contrast, the fuel cell system 210 according to the second embodiment relaxes the electrical current limitation of the fuel cell stack 12 caused by the deceleration buffer 74, and optimizes the limited range of charging and discharging 68 of the power storage device 244. In the following description of the second embodiment, the same components as those of the first embodiment are denoted by the same reference numerals. Descriptions which overlap or are duplicative with those of the first embodiment will be omitted as appropriate.

### Current Limit of Fuel Cell Stack 12

The fuel cell system 210 according to the second embodiment sets an upper limit for the generated current Ifc of the fuel cell stack 12 in order to control the generated current Ifc. This upper limit is referred to as a current limit of the fuel cell stack 12 or simply as an FC current limit.

Normally, the FC current limit is set to a rated current that is the maximum output of the fuel cell stack 12. However, in the case where the deceleration buffer 74 is insufficient and the deceleration rate (the rate of change over time in the rotational speed during deceleration) of the air pump 112 cannot satisfy a predetermined condition, a small current during idle power generation may be set as the FC current limit. In the present specification, the predetermined condition to be satisfied by the deceleration rate of the air pump 112 is referred to as a wetness controlling condition of the fuel cell stack 12.

### Wetness Controlling Conditions of Fuel Cell Stack 12

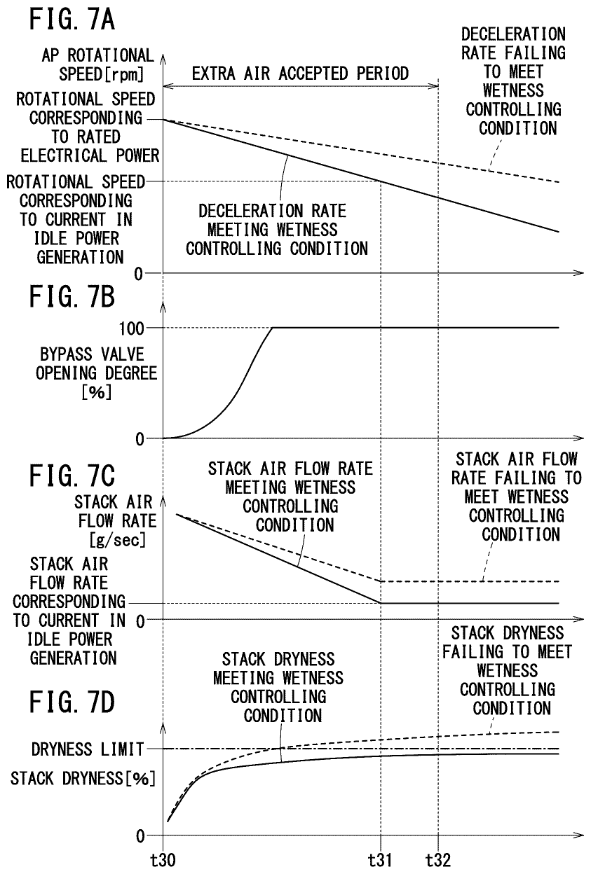

The wetness controlling conditions of the fuel cell stack 12 will be described with reference to FIGS. 7A to 7D.

FIG. 7A shows a change over time in the rotational speed (AP rotational speed) [rpm] of the air pump 112 during deceleration of the air pump 112, that is, a deceleration rate [rpm/see] of the air pump 112. FIG. 7B shows a change over time in the opening degree [%] of the bypass valve 120, and FIG. 7C shows a change over time in the flow rate of the oxygen-containing gas (stack air flow rate) [g/sec] flowing through the fuel cell stack 12. FIG. 7D shows the change over time in the dryness of the fuel cell stack 12 (stack dryness).

In FIGS. 7A to 7D, time t30 is an initial state. In the initial state, the fuel cell stack 12 outputs a predetermined rated current, and the air pump 112 rotates at a rotational speed corresponding to the rated current of the fuel cell stack 12. Here, the predetermined rated current of the fuel cell stack 12 is a current value set on the basis of the I-V characteristics (current-voltage characteristics) of the fuel cell stack 12, and may be, for example, the maximum value of the current which the fuel cell stack 12 can stably output. In each of the drawings, the time from time t30 to time t32 is referred to as the extra air accepted period.

In the extra air accepted period, an extra amount of the oxygen-containing gas is allowed to flow inside the fuel cell stack 12 when the rotational speed of the air pump 112 is being decreased to a rotational speed corresponding to the current in idle power generation.

The current in the idle power generation is, for example, a small current that can drive the air pump 112 at the minimum rotational speed at which the rotor shaft 274 of the air pump 112 can float. Alternatively, the current in idle power generation may be such a small current that the power generated by the fuel cell stack 12 and the power consumed by the air pump 112 substantially match.

The extra air accepted period is set in a range of, for example, several seconds, depending on the specifications of the fuel cell system 210 including the fuel cell stack 12.

In the case where the rotational speed of the air pump 112 is reduced to the rotational speed corresponding to the current in the idle power generation within the extra air accepted period, the interior of the fuel cell stack 12 is prevented from becoming dry. In this case, the deceleration rate satisfies the wetness controlling condition. On the other hand, in the case where the rotational speed of the air pump 112 is not reduced to the rotational speed corresponding to the current in the idle power generation within the extra air accepted period, the interior of the fuel cell stack 12 becomes dry. In this case, the deceleration rate does not satisfy the wetness controlling condition.

In FIG. 7A, a solid line graph is an example of the deceleration rate satisfying the wetness controlling condition. The rotational speed of the air pump 112 gradually decreases from time t30, and reaches the rotational speed corresponding to the current in the idle power generation at time t31.

The solid line graph in FIG. 7B indicates that the bypass valve 120 starts to be driven toward the full open state (opening degree of 100%) from time t30. The bypass valve 120 reaches the full open state prior to time t31.

The solid line graph in FIG. 7C indicates that the oxygen-containing gas flows through the fuel cell stack 12 at a flow rate corresponding to the rated current at time t30. The flow rate of the oxygen-containing gas flowing through the fuel cell stack 12 gradually decreases, and reaches a flow rate corresponding to the current in the idle power generation at time t31. The flow rate of the oxygen-containing gas flowing through the fuel cell stack 12 is maintained at a flow rate corresponding to the current in the idle power generation even after time t31.

The solid line graph in FIG. 7D shows that the dryness in the fuel cell stack 12 is low at time t30. When the rotational speed of the air pump 112 starts to decelerate, the amount of power generated by the fuel cell stack 12 decreases, and the amount of water produced in the fuel cell stack 12 decreases. On the other hand, the oxygen-containing gas continues to flow through the fuel cell stack 12 after time t30. The dryness in the fuel cell stack 12 gradually increases. However, the dryness in the fuel cell stack 12 is maintained below the dryness limit even after time t31.

On the other hand, the broken line graphs in each of FIGS. 7A, 7C, and 7D show an example of a case where the wetness controlling condition is not satisfied.

As shown in FIG. 7A, the deceleration rate in the case where the wetness controlling condition is not satisfied is smaller than the deceleration rate in the case where the wetness controlling condition is satisfied. Therefore, at time t32, the rotational speed of the air pump 112 in the case where the wetness controlling condition is not satisfied exceeds the rotational speed corresponding to the current in the idle power generation. At time t32 in FIG. 7C, the flow rate of the oxygen-containing gas flowing through the fuel cell stack 12 exceeds the flow rate corresponding to the current in the idle power generation. As a result, the stack dryness exceeds the dryness limit at time t32 as shown in FIG. 7D. That is, when the deceleration rate does not satisfy the wetness controlling condition, the fuel cell stack 12 is dried.

As described above, the fuel cell system 210 according to the second embodiment can be controlled to avoid drying of the fuel cell stack 12 during deceleration of the air pump 112 by using the wetness controlling condition that includes the relationship between the rotational speed of the air pump 112 corresponding to the FC current limit (normally, the rated current), the rotational speed of the air pump 112 corresponding to the current in the idle power generation, and the extra air accepted period.

It should be noted that the fuel cell system 210 includes the bypass valve 120. The opening degree of the bypass valve 120 is not limited to the example shown in FIG. 7B. The opening degree of the bypass valve 120 may not be full (opening degree 100%). The opening degree of the bypass valve 120 can be changed as appropriate. The flow rate of the oxygen-containing gas flowing through the fuel cell stack 12 may be adjusted by controlling the inlet stop valve 116 and the outlet stop valve 118 in addition to the bypass valve 120. The rotational speed of the air pump 112 corresponding to the current in the idle power generation can be changed according to the opening degree of the bypass valve 120. If the opening degree of the bypass valve 120 is increased, the flow rate of the oxygen-containing gas flowing toward the fuel cell stack 12 decreases, and thus the rotational speed of the air pump 112 corresponding to the current in the idle power generation may be high. In this case, the surplus electrical power Δ AP generated in the air pump 112 during deceleration of the air pump 112 is small, and there is an advantage that the deceleration buffer 74 small in size may suffice.

### Setting of Current Limit

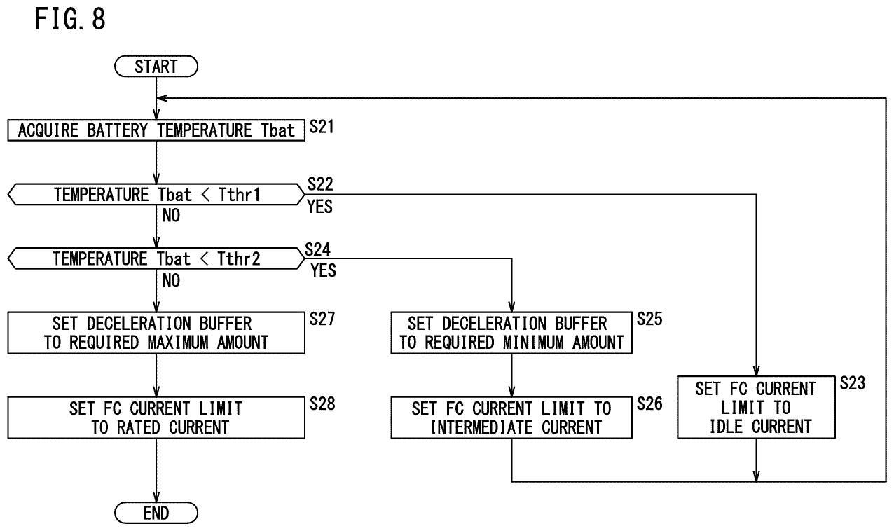

Next, a flow of setting the current limit (FC current limit) of the fuel cell stack 12 by the control device 26 will be described with reference to a flowchart of FIG. 8.

In step S21, the control device 26 acquires the temperature That of the power storage device (battery) 244 from the temperature sensor 250.

In step S22, the control device 26 compares the temperature Tbat with a threshold temperature Tthr1. The threshold temperature Tthr1 is a threshold between an extremely low temperature range (for example, less than 0° C.) and a low temperature range (for example, 0° C. or more and less than 5° C.), and is set to, for example, 0° C.

If the temperature That is lower than the threshold temperature Tthr1 (step S22: YES), the control device 26 determines that the size of the limited range of charging and discharging 68 of the power storage device 244 is too small. The control device 26 proceeds to step S23 without setting the buffer 70 (the acceleration buffer 72 and the deceleration buffer 74).

In step S23, the control device 26 sets the current (idle current) in the idle power generation as the FC current limit. The control device 26 waits for the power storage device 244 to be heated for a predetermined time.

Returning to step S21, the control device 26 again acquires the temperature Tbat of the power storage device (battery) 244 from the temperature sensor 250.

In step S22, the control device 26 compares the temperature Tbat with a threshold temperature Tthr1. In the case where the temperature Tbat is equal to or higher than the threshold temperature Tthr1 (step S22: NO), the limited range of charging and discharging 68 of the power storage device 244 is slightly expanded as compared with the case in the extremely low temperature range. The control device 26 determines that the buffer 70 (the deceleration buffer 74 and the acceleration buffer 72) can be set within the limited range of charging and discharging 68 of the power storage device 244, and proceeds to step S24.

In step S24, the control device 26 compares the temperature That with a threshold temperature Tthr2. The threshold temperature Tthr2 is a threshold between the low temperature range (for example, 0° C. or more and less than 5° C.) and a normal temperature range (for example, 5° C. or more), and is, for example, 5° C.

If the temperature Tbat is lower than the threshold temperature Tthr2 (step S24: YES), the control device 26 determines that the buffer 70 (deceleration buffer 74, acceleration buffer 72) of a minimum size can be set within the limited range of charging and discharging 68 of the power storage device 244, and proceeds to step S25.

In step S25, the control device 26 sets the deceleration buffer 74 to the minimum buffer width (required minimum amount). The minimum buffer width of the deceleration buffer 74 may be, for example, a minimum electrical amount required to absorb variations such as a measurement error of the flow rate sensor 107 and a quantity error of the inverter 252.

In step S25, the control device 26 also sets the acceleration buffer 72 simultaneously with setting the deceleration buffer 74. For example, the acceleration buffer 72 is set to the minimum buffer width (required minimum amount). The minimum buffer width of the acceleration buffer 72 may be, for example, the amount of electrical power required to rotate the air pump 112 at the minimum rotational speed (the minimum value of the rotational speed required for the rotor shaft 274 of the air pump 112 to float).

Next, in step S26, the control device 26 changes the FC current limit to be larger than the current in the idle power generation (idle current), in accordance with the temperature Tbat. The FC current limit is set between the current in the idle power generation and the rated current. The current between the current in the idle power generation and the rated current is hereinafter referred to as an intermediate current.

When the FC current limit is raised from the current in the idle power generation to the intermediate current, the fuel cell stack 12 can generate a current larger than the current in the idle power generation. For example, when the electrical power generated by the fuel cell stack 12 is supplied to the battery heater 251, the battery heater 251 can heat the power storage device 244. The control device 26 waits for the power storage device 244 to be heated for a predetermined time.

If the temperature That is equal to or higher than the threshold temperature Tthr2 (step S24: NO), the control device 26 determines that a large buffer 70 (deceleration buffer 74, acceleration buffer 72) can be set within the limited range of charging and discharging 68 of the power storage device 244, and proceeds to step S27.

In step S27, the control device 26 sets the deceleration buffer 74 to the maximum buffer width (maximum required value). The maximum buffer width of the deceleration buffer 74 may be calculated based on the deceleration rate at which the output of the fuel cell stack 12 is reduced from the rated current to the current in the idle power generation within the extra air accepted period.

The control device 26 changes the buffer width of the acceleration buffer 72 according to the temperature That when setting the deceleration buffer 74. The buffer width of the acceleration buffer 72 may be set based on the amount of electrical power required to rotate the air pump 112 at the maximum acceleration rate.

Next, in step S28, the control device 26 changes the FC current limit from the intermediate current to the rated current. Thus, the fuel cell stack 12 can generate electrical power at the rated current, and can supply electrical power to a high-voltage load such as the motor 246 in addition to a low-voltage load such as the battery heater 251.

### Operation Explanation Using Timing Chart

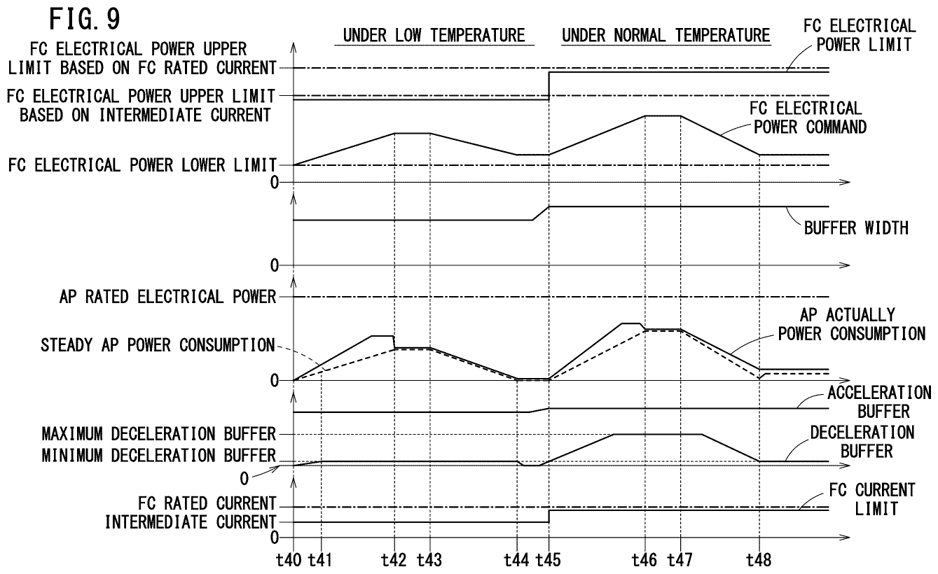

An example of the operation described with reference to the flowchart of FIG. 8 will be described with reference to the timing chart of FIG. 9.

FIG. 9 is a timing chart showing an example of changes in the actual AP power consumption and the steady AP power consumption of the air pump 112 under low temperature and under normal temperature.

At time t40, it is determined that the temperature That of the power storage device 244 is low (step S24: YES). The deceleration buffer 74 is set to the minimum buffer width, and the acceleration buffer 72 is set to the minimum buffer width (step S25). The FC current limit is set to the intermediate current (step S26). At this time, the upper limit of the FC electrical power (FC electrical power limit) is the FC electrical power upper limit based on the intermediate current.

At time t40, the control device 26 receives a target generated power (FC electrical power command) of the fuel cell stack 12. When the control device 26 instructs the air pump 112 to rotate at a target rotational speed, the air pump 112 starts to accelerate its rotational speed and the actual AP power consumption and the steady AP power consumption start to increase.

From time t40 to time t41, the steady AP power consumption is assigned to the deceleration buffer 74, and the deceleration buffer 74 slightly increases. After time t41, the upper limit of the deceleration buffer 74 is maintained at the minimum buffer width set in step S25.

At time t42, the air pump 112 stops acceleration, and the air pump 112 is in a constant state. At this time, the actual AP power consumption and the steady AP power consumption substantially match. The fuel cell stack 12 may provide electrical power to a low-voltage load, such as the battery heater 251.

At time t43, the air pump 112 starts to decelerate. The deceleration buffer 74 is set to the minimum value. Here, the control device 26 decelerates the air pump 112 at a deceleration rate at which the surplus electrical power (the difference between the actual AP power consumption and the steady AP power consumption) Δ AP is not generated in the air pump 112. At time t44, the deceleration of the air pump 112 ends.

At time t45, it is determined that the temperature That of the power storage device 244 falls in the normal temperature range (step S24: NO). The deceleration buffer 74 is set to the maximum buffer width (step S27), and the acceleration buffer 72 is set to an appropriate buffer width. The control device 26 changes the FC current limit from the intermediate current to the rated current (step S28). At this time, the upper limit of the FC generated power (FC electrical power limit) is opened to the upper limit based on the FC rated current.

At time t45, the control device 26 receives a target generated power (FC electrical power command) of the fuel cell stack 12. When the control device 26 controls the air pump 112 to rotate at a target rotational speed, the air pump 112 starts to accelerate its rotational speed and the actual AP power consumption and the steady AP power consumption start to increase.

From time t45 to time t46, the steady AP power consumption is allocated to the deceleration buffer 74, and the upper limit of the deceleration buffer 74 is maintained at the maximum buffer width set in step S27.

At the time t47, the air pump 112 starts to decelerate. Since the deceleration buffer 74 is set to the maximum required size (step S27), the power storage device 244 can be charged with the surplus power Δ AP generated by the difference between the actual AP power consumption and the steady AP power consumption. At time t48, the deceleration of the air pump 112 ends.

### Comparative Example

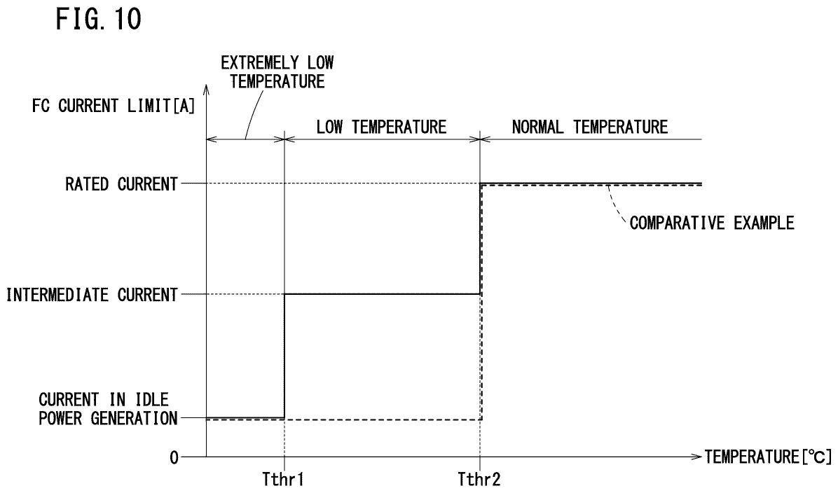

FIG. 10 is an explanatory diagram showing an example of the FC current limit value according to the temperature That of the power storage device 244.

The broken line in FIG. 10 indicates a comparative example. In the comparative example, at the time when the temperature falls within the extremely low temperature range and at the time when the temperature falls within the low temperature range, the FC current limit is fixed to the current in the idle power generation. The FC current limit is increased to the rated current only when the temperature That of the power storage device 244 reaches the threshold (threshold Tthr2) between the low temperature and the normal temperature.

In this comparative example, the rotational speed of the air pump 112 corresponding to the current in the idle power generation is low, and therefore the deceleration rate that satisfies the wetness controlling condition is high. When the air pump 112 is decelerated, a large surplus electrical power Δ AP may be generated. Therefore, it is necessary to secure a large buffer width corresponding to the deceleration rate in the deceleration buffer 74. Therefore, in this comparative example, the FC current limit is not raised to the rated current until the buffer width required for the deceleration buffer 74 can be secured, and the FC current limit is fixed to the current in the idle power generation.

The solid line in FIG. 10 shows an example of the FC current limit in the fuel cell system 210. In the fuel cell system 210, when the temperature That of the power storage device 244 is extremely low, the FC current limit is set to the current in the idle power generation (step S23). When the temperature That of the power storage device 244 reaches the threshold (thresholds Tthr1) between the extremely low temperature range and the low temperature range, the FC current limit is switched to the intermediate current (step S26). When the temperature That of the power storage device 244 reaches the threshold between the low temperature range and the normal temperature range (threshold Tthr2), the FC current limit is increased to the rated current (step S28).

As described above, the fuel cell system 210 according to the second embodiment changes the FC current limit from the current in the idle power generation to the intermediate current and allows the fuel cell stack 12 to generate electrical power even when a sufficient deceleration buffer 74 cannot be secured in the power storage device 244 at a low temperature. For example, the electrical power can be supplied to a low-voltage load such as the battery heater 251, and the power storage device 244 can be heated by using the battery heater 251. This makes it possible to shift a moving body such as the fuel cell vehicle 11 equipped with the fuel cell stack 12 to a travelable state (operable state) at an early stage.

The intermediate current shown in FIG. 10 is an example, and the intermediate current may be set in plurality between the rated current and the current in the idle power generation. The intermediate current may be set so that the graph of FIG. 10 shows a single-step or multiple-step increase or a monotonic increase in a curved line in accordance with the temperature That of the power storage device 244.

With respect to the above disclosure, the following Supplementary Notes 1 to 9 are disclosed.

### Supplementary Note 1

There is provided the fuel cell system (10) including: the fuel cell (12) configured to generate electrical power using a fuel gas and an oxygen-containing gas; the pump (112) configured to feed the oxygen-containing gas to the fuel cell;
the power storage device (244) configured to be able to supply electrical power to the pump; and the control device (26) configured to control power generation of the fuel cell and charging and discharging of the power storage device, wherein the control device sets the range (68) of an amount of electrical power chargeable to and dischargeable from the power storage device, the range of the amount of electrical power chargeable to and dischargeable from the power storage device including the buffer (70) including an acceleration buffer (72) as an amount of electrical power dischargeable from the power storage device to the pump at a time of accelerating the rotational speed of the pump, and wherein the control device calculates steady power consumption of the pump and sets the acceleration buffer based on the steady power consumption (steady AP power consumption) and rated electrical power of the pump.

In this structure, the control device 26 sets the acceleration buffer 72 based on the steady AP power consumption and the rated electrical power of the air pump 112. The control device 26 secures the acceleration buffer 72 necessary for driving the air pump 112 within the limited range of charging and discharging 68 of the power storage device 244. On the other hand, the control device 26 does not set aside an excessive (unnecessary) amount of electrical power that is not requested to drive the air pump 112, as the acceleration buffer 72. Therefore, the energy management control range (EM control range) 76 that can be used by the load 21 other than the air pump 112 can be expanded.

In this manner, the fuel cell system 10 optimizes the range (limited range of charging and discharging 68) of the amount of electrical power that can be charged to and discharged from a power storage device 244.

### Supplementary Note 2

In the fuel cell system according to Supplementary Note 1, the control device may decrease the acceleration buffer in accordance with the steady power consumption in a case where a total of the acceleration buffer and the steady power consumption exceeds the rated electrical power of the pump.

In accordance with such a configuration, the control device 26 controls the amount obtained by adding the acceleration buffer 72 and the steady AP power consumption not to exceed the rated electrical power of the air pump 112. The control device 26 can accurately allocate an amount required just for driving the air pump 112 to the acceleration buffer 72 with respect to the limited range of charging and discharging 68.

In this manner, the fuel cell system 10 can further optimize the range (limited range of charging and discharging 68) of the amount of electrical power that can be charged to and discharged from a power storage device 244.

### Supplementary Note 3

In the fuel cell system according to Supplementary Note 1 or 2, the control device may cover a shortage of electrical power for the steady power consumption with electrical power generated by the fuel cell.

In accordance with such a configuration, the electrical power corresponding to the steady AP power consumption out of the actual AP power consumption required for the acceleration of the rotational speed of the air pump 112 is covered by the electrical power generated by the fuel cell stack 12. The power shortage occurring in the air pump 112 is at least the difference between the actual AP power consumption and the steady AP power consumption (Δ AP in the period from time t1 to time t2 in FIG. 4). The power storage device 244 can compensate for the power shortage (Δ AP) of the air pump 112 within the range of the acceleration buffer 72. In this manner, the fuel cell system 10 optimizes the range of the amount of electrical power (limited range of charging and discharging 68) that can be charged to and discharged from a power storage device 244 with high accuracy.

### Supplementary Note 4

In the fuel cell system according to any one of Supplementary Notes 1 to 3, the control device may charge the electric storage device with the electrical power generated by the fuel cell, and supply the electrical power charged in the electric storage device to the pump.

In accordance with such a configuration, in the case where the electrical power storage device 244 supplies the air pump 112 with the electrical power generated by the fuel cell stack 12, the electrical power charged in the electrical power storage device 244 in advance can be added thereto.

### Supplementary Note 5

There is provided the method for controlling charge and discharge of the power storage device (244) of the fuel cell system (10) including: the fuel cell (12) configured to generate electrical power using a fuel gas and an oxygen-containing gas; the pump (112) configured to feed the oxygen-containing gas to the fuel cell; a power storage device configured to be able to supply electrical power to the pump;
and the control device (26) configured to control power generation of the fuel cell and charging and discharging of the power storage device, wherein the control device sets the range (68) of an amount of electrical power chargeable to and dischargeable from the power storage device, the range of the amount of electrical power chargeable to and dischargeable from the power storage device including the buffer (70) including an acceleration buffer (72) as an amount of electrical power dischargeable from the power storage device to the pump at a time of accelerating the rotational speed of the pump, and wherein the control device calculates steady power consumption (steady AP power consumption) of the pump and sets the acceleration buffer based on the steady power consumption and rated electrical power of the pump.

In this manner, the control device 26 sets the acceleration buffer 72 based on the steady AP power consumption and the rated electrical power of the air pump 112. The control device 26 secures the acceleration buffer 72 necessary for driving the air pump 112 within the limited range of charging and discharging 68 of the power storage device 244. On the other hand, the control device 26 does not set aside an excessive (unnecessary) amount of electrical power that is not requested to drive the air pump 112, as the acceleration buffer 72. Therefore, the energy management control range (EM control range) 76 that can be used by the load 21 other than the air pump 112 can be expanded.

In this manner, it is possible to optimize the range (limited range of charging and discharging 68) of the amount of electrical power that can be charged to and discharged from a power storage device 244.

### Supplementary Note 6

There is provided the fuel cell system (210) including: the fuel cell (12) configured to generate electrical power using a fuel gas and an oxygen-containing gas; the pump (112) configured to feed the oxygen-containing gas to the fuel cell; the power storage device (244) configured to be able to supply of electrical power to the pump; the control device (26) configured to control power generation of the fuel cell and charging and discharging of the power storage device; and the temperature measurement device (250) configured to measure a temperature (Tbat) of the power storage device, wherein the control device sets the range (68) of an amount of electrical power chargeable to and dischargeable from the power storage device, the range of the amount of electrical power chargeable to and dischargeable from the power storage device including the buffer (70) including the deceleration buffer (74) as an amount of electrical power (ΔAP) chargeable to the power storage device in a case where a surplus of electrical power generated due to deceleration of a rotational speed of the pump, and wherein the control device changes a buffer width of the deceleration buffer in accordance with the temperature of the power storage device, switches a current limit of the fuel cell (FC current limit) based on the buffer width of the deceleration buffer, and causes the fuel cell to generate electrical power with the current limit as switched (intermediate current).

According to such a configuration, for example, even when a sufficient deceleration buffer 74 cannot be secured under low temperature, the FC current limit of the fuel cell stack 12 is switched to the intermediate current, and the fuel cell is caused to generate electrical power.

Thus, for example, electrical power can be supplied to a low-voltage load such as the battery heater 251, and the power storage device 244 can be heated by using the battery heater 251. The heating of the power storage device 244 expands the limited ranged of charging and discharging 68, and the range of the amount of electrical power chargeable to and dischargeable from the power storage device 244 can be optimized. This makes it possible to shift a moving body such as the fuel cell vehicle 11 equipped with the fuel cell stack 12 to a travelable state (operable state) at an early stage. Further, when the outside air temperature is low, an occupant of the fuel cell vehicle 11 can use an air conditioner. The occupant can also use electrical power inside the fuel cell vehicle 11.

### Supplementary Note 7

In the fuel cell system according to Supplementary Note 6, the control device may switch the current limit of the fuel cell based on the buffer width of the deceleration buffer and the rate of change over time in the rotational speed of the pump, and cause the fuel cell to generate electrical power with the current limit as switched.

According to such a configuration, the FC current limit is switched by taking into account the rate of change over time in the rotational speed (deceleration rate) of the air pump 112 in addition to the buffer width of the deceleration buffer 74. Thus, for example, electrical power can be supplied to a low-voltage load such as the battery heater 251 at an early stage.

### Supplementary Note 8

The fuel cell system according to Supplementary Note 6 or 7 may further include: the oxygen-containing gas supply path (106) configured to allow the oxygen-containing gas to be supplied to the fuel cell; the inlet stop valve (116) disposed in the oxygen-containing gas supply path between the pump and the fuel cell; the discharge path (109) configured to allow the oxygen-containing gas to be discharged from the fuel cell to the outside; the bypass flow path (110) configured to allow the oxygen-containing gas supplied to the oxygen-containing gas supply path to flow from the upstream side of the inlet stop valve to the discharge path; and the bypass valve (120) disposed in the bypass flow path between the oxygen-containing gas supply path and the discharge path, wherein the control device switches a current limit of the fuel cell on the basis of the buffer width of the deceleration buffer and an opening degree of the bypass valve, and causes the fuel cell to generate electrical power with the current limit as switched.

According to such a configuration, the FC current limit is changed by taking into account the opening degree of the bypass valve 120 in addition to the buffer width of the deceleration buffer 74. Thus, for example, power can be supplied to a low-voltage load such as the battery heater 251 at an early stage.

### Supplementary Note 9

There is provided a method of controlling the fuel cell system (210) including: the fuel cell (12) configured to generate electrical power using a fuel gas and an oxygen-containing gas; the pump (112) configured to supply the oxygen-containing gas to the fuel cell; the power storage device (244) configured to enable supply of electrical power to the pump; the control device (26) configured to control power generation of the fuel cell and charging and discharging of the power storage device; and the temperature measurement device (250) configured to measure a temperature (Tbat) of the power storage device, wherein the control device sets the range (68) of an amount of electrical power chargeable to and dischargeable from the power storage device, the range of the amount of electrical power chargeable to and dischargeable from the power storage device including the buffer (70) including the deceleration buffer (74) as an amount of surplus electrical power (ΔAP) chargeable to the power storage device at a time of decelerating a rotational speed of the pump, and wherein the method including the steps of changing (steps S25, S27) a buffer width of the deceleration buffer in accordance with the temperature of the power storage device, switching (steps S23, S26, S28) a current limit of the fuel cell based on the buffer width of the deceleration buffer, and causing the fuel cell to generate electrical power with the current limit as switched.

In such a manner, for example, even when a sufficient deceleration buffer 74 cannot be secured under low temperature, the FC current limit of the fuel cell stack 12 is switched to the intermediate current, and the fuel cell is caused to generate electrical power.

Thus, for example, electrical power can be supplied to a low-voltage load such as the battery heater 251, and the power storage device 244 can be heated by using the battery heater 251. The heating of the power storage device 244 expands the limited ranged of charging and discharging 68, and the range of the amount of electrical power chargeable to and dischargeable from the power storage device 244 can be optimized. This makes it possible to shift a moving body such as the fuel cell vehicle 11 equipped with the fuel cell stack 12 to a travelable state (operable state) at an early stage. Further, when the outside air temperature is low, an occupant of the fuel cell vehicle 11 can use an air conditioner. The occupant can also use electrical power inside the fuel cell vehicle 11.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

1. A fuel cell system comprising:
a fuel cell configured to generate electrical power using a fuel gas and an oxygen-containing gas;
a pump configured to feed the oxygen-containing gas to the fuel cell;
a power storage device configured to be able to supply electrical power to the pump; and
one or more processors that execute computer-executable instructions stored in a memory,
wherein the one or more processors execute the computer-executable instructions to cause the fuel cell system to:
set a range of an amount of electrical power chargeable to and dischargeable from the power storage device, the range of the amount of electrical power chargeable to and dischargeable from the power storage device including a buffer including an acceleration buffer as an amount of electrical power dischargeable from the power storage device to the pump at a time of accelerating the rotational speed of the pump,
calculate steady power consumption of the pump, and
set the acceleration buffer based on the steady power consumption and rated electrical power of the pump.

2. The fuel cell system according to claim 1, wherein
the one or more processors cause the fuel cell system to: decrease the acceleration buffer in accordance with the steady power consumption in a case where a total of the acceleration buffer and the steady power consumption exceeds the rated electrical power of the pump.

3. The fuel cell system according to claim 2, wherein
the one or more processors cause the fuel cell system to:
cover a shortage of electrical power for the steady power consumption with electrical power generated by the fuel cell.

4. The fuel cell system according to claim 3, wherein
the one or more processors cause the fuel cell system to:
charge the electric storage device with the electrical power generated by the fuel cell, and
supply the electrical power charged in the electric storage device to the pump.

5. A method for controlling charge and discharge of a power storage device of a fuel cell system, the fuel cell system comprising:
a fuel cell configured to generate electrical power using a fuel gas and an oxygen-containing gas;
a pump configured to feed the oxygen-containing gas to the fuel cell;
a power storage device configured to be able to supply electrical power to the pump; and
the method comprising:
setting a range of an amount of electrical power chargeable to and dischargeable from the power storage device, the range of the amount of electrical power chargeable to and dischargeable from the power storage device including a buffer including an acceleration buffer as an amount of electrical power dischargeable from the power storage device to the pump at a time of accelerating the rotational speed of the pump,
calculating steady power consumption of the pump, and
setting the acceleration buffer based on the steady power consumption and rated electrical power of the pump.

6. A fuel cell system comprising:
a fuel cell configured to generate electrical power using a fuel gas and an oxygen-containing gas;
a pump configured to feed the oxygen-containing gas to the fuel cell;
a power storage device configured to be able to supply electrical power to the pump;
a temperature measurement device configured to measure a temperature of the power storage device; and
one or more processors that execute computer-executable instructions stored in a memory,
wherein the one or more processors cause the fuel cell system to:
set a range of an amount of electrical power chargeable to and dischargeable from the power storage device, the range of the amount of electrical power chargeable to and dischargeable from the power storage device including a buffer including a deceleration buffer as an amount of electrical power chargeable to the power storage device in a case where a surplus of electrical power generated due to deceleration of a rotational speed of the pump,
change a buffer width of the deceleration buffer in accordance with a temperature of the power storage device,
switch a current limit of the fuel cell based on the buffer width of the deceleration buffer, and
cause the fuel cell to generate electrical power with the current limit as switched.

7. The fuel cell system according to claim 6, wherein
the one or more processors cause the fuel cell system to:
switch the current limit of the fuel cell based on the buffer width of the deceleration buffer and a rate of change over time in the rotational speed of the pump, and
cause the fuel cell to generate electrical power with the current limit as switched.

8. The fuel cell system according to claim 6, further comprising:
an oxygen-containing gas supply path configured to allow the oxygen-containing gas to be supplied to the fuel cell;
a stop valve disposed in the oxygen-containing gas supply path between the pump and the fuel cell;
a discharge path configured to allow the oxygen-containing gas to be discharged from the fuel cell to an outside;
a bypass flow path configured to allow the oxygen-containing gas supplied to the oxygen-containing gas supply path to flow from an upstream side of the stop valve to the discharge path; and
a bypass valve disposed in the bypass flow path between the oxygen-containing gas supply path and the discharge path,
wherein the one or more processors cause the fuel cell system to:
switch a current limit of the fuel cell on a basis of the buffer width of the deceleration buffer and an opening degree of the bypass valve, and
cause the fuel cell to generate electrical power with the current limit as switched.
